(19) United States
(12) Patent Application Publication
(10) Pub. No.: US 2026/0275146 A1
(43) Pub. Date: Sep. 17, 2026

(54) LIGHTWEIGHT HYBRID PLASTISOL COMPOSITION FOR SEAM SEALING, ROOF DITCH FILLING, AND UNDERBODY COATING IN AUTOMOTIVE MANUFACTURING PROCESSES

(71) Applicants: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(72) Inventors: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(21) Appl. No.: 19/077,213

(22) Filed: Mar. 12, 2025

(51) Int. Cl. C09D 127/06; C09D 7/20; C09D 7/40; C09D 7/62; C09D 7/63; C09D 7/80

(52) U.S. Cl. CPC C09D 127/06; C09D 7/20; C09D 7/62; C09D 7/63; C09D 7/69; C09D 7/70; C09D 7/80

(57) ABSTRACT

A lightweight PVC-based plastisol composition is provided for use as a seam sealer, roof ditch filler, and underbody coating in automotive manufacturing. Comprising PVC resins, plasticizers, a blocked isocyanate adhesion promoter, coated calcium carbonate, and low-density glass microspheres, the composition has a density of 0.7-1.0 g/cc, cures at 110-190° C., and is compatible with conventional, 3-wet, and 4-wet paint systems. It offers excellent adhesion, abrasion resistance, and paintability, reducing vehicle weight and enhancing fuel efficiency.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to coating compositions for automotive applications, and more particularly to a lightweight polyvinyl chloride (PVC)-based plastisol composition designed for multiple applications in automotive manufacturing processes (e.g., the paint shop stage). Specifically, the invention pertains to a hybrid plastisol composition suitable for use as a seam sealer, roof ditch filler, and underbody coating, curable in a manufacturing oven, offering reduced density, enhanced fuel efficiency, and compatibility with modern painting processes.

### 2. Background of the Invention

In automotive manufacturing, the assembly process involves distinct stages, including the body shop and paint shop. In the body shop, structural components are joined using adhesives and sealants tailored for bonding lubricated bare metal substrates. Once assembled, the vehicle body is transferred to the paint shop, where it undergoes electrodeposition coating (E-coat), sealing, underbody coating, and painting, followed by curing in a paint bake oven.

Conventionally, automotive manufacturers employ multiple specialized sealants in the paint shop stage to meet functional requirements: PVC-based seam sealers for sealing joints (e.g., doors, hoods, and interiors), roof ditch sealers for filling roof channels, and underbody coatings (often PVC or water-based) for protecting against chipping, rust, and corrosion from road debris. These sealants typically have densities ranging from 1.4 to 1.6 g/cc, contributing approximately 15 to 20 kg of weight per vehicle. This weight impacts fuel efficiency, a critical concern as the automotive industry seeks to reduce its carbon footprint, which accounts for about 15% of global CO₂ emissions.

Prior solutions rely on separate products for each application, necessitating dedicated storage, equipment, and application processes. This increases complexity, cost, and the risk of errors such as misloading products into incorrect applicators. Furthermore, conventional sealants often fail to achieve low density while maintaining performance properties like adhesion, abrasion resistance, and paintability across modern paint systems (e.g., conventional, 3-wet, and 4-wet processes).

Efforts to reduce vehicle weight and improve sustainability have driven innovations like 3-wet and 4-wet paint processes, which eliminate curing stages, reducing CO₂ emissions by up to 5 kg and 10 kg per vehicle, respectively. However, sealants compatible with these processes while also reducing density remain limited.

There remains a need for a single, lightweight coating composition that serves multiple paint shop functions-seam sealing, roof ditch filling, and underbody protection-while offering low density, robust mechanical properties, and compatibility with diverse paint systems, thereby simplifying manufacturing, reducing weight, and enhancing fuel efficiency.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention addresses current manufacturing challenges through an innovative lightweight hybrid plastisol composition designed for a plurality of automotive manufacturing processes. This single-component PVC-based plastisol serves as a seam sealer, roof ditch filler, and underbody coating, achieving a density of 0.7 to 1.0 g/cc—up to 50% lower than conventional sealants—while maintaining excellent adhesion, mechanical strength, and paintability.

In one embodiment, the present invention is directed to a novel plastisol composition comprising, consisting essentially of and/or consisting of: (a) 15-20 wt. % polyvinyl chloride (PVC) homopolymer; (b) 10-20 wt. % PVC copolymer; (c) 5-15 wt. % PVC terpolymer; (d) 20-35 wt. % plasticizer (e.g., benzoate and phthalate esters); (e) 1-15 wt. % blocked isocyanate adhesion promoter; (f) 5-15 wt. % coated calcium carbonate filler; (g) 5-15 wt. % low-density hollow glass microspheres; (h) 1-10 wt. % odorless mineral spirit solvent; (i) 0-5 wt. % epoxy resin; and (j) optional additives (e.g., rheology modifiers, stabilizers, catalysts). The composition cures at 110-190° C., compatible with paint shop ovens, and achieves properties such as 60-70 Pa·s viscosity, 2.0-3.0 MPa overlap strength, and 70-90% elongation.

The invention also encompasses methods for applying the composition to automotive substrates (e.g., E-coated metal) and curing it within conventional, 3-wet, or 4-wet paint processes, reducing vehicle weight by approximately 1% and improving fuel efficiency by 10-15%.

Advantages include: a single product replacing multiple sealants, reduced density for weight savings, excellent abrasion resistance, self-leveling flow for roof ditch applications, and compatibility with modern paint systems, all contributing to simplified manufacturing and sustainability goals.

### BRIEF DESCRIPTION OF THE DRAWINGS

Certain embodiments of the present invention are illustrated by the accompanying figures. It will be understood that certain figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a cross-sectional schematic representation of a substrate/component assembly associated with a cured lightweight hybrid plastisol composition in accordance with the present invention.

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

The present invention provides lightweight hybrid plastisol compositions that unify the functions of seam sealing, roof ditch filling, and underbody coating in automotive paint shop applications. The compositions leverage a novel blend of PVC resins, plasticizers, adhesion promoters, and low-density fillers to achieve superior performance with reduced weight.

### Definitions

Plastisol: A suspension of PVC resin particles in a plasticizer that gels and fuses upon heating.

Hybrid Application: Use of a single composition for multiple functions (seam sealing, roof ditch filling, underbody coating).

Density: Mass per unit volume (g/cc), measured at 25° C. and 1 atmosphere (atm).

E-coat: Electrodeposition coating applied to metal substrates for corrosion resistance.

Conventional Paint Process: Sealer applied and cured, and then multiple layers of paint applied and cured in sequential oven stages, each requiring curing before proceeding to the next stage. Typically emits around 30 kg of CO₂ per vehicle manufactured.

3-Wet Paint Process: A process where sealer applied and cured, primer, base coat, and topcoat are applied wet without intermediate curing steps then all the paints cured in one final stage, reducing CO₂ emissions by up to 5 kg per vehicle.

4-Wet Paint Process: An optimized process where sealer, primer, base coat, and topcoat are applied wet without intermediate curing steps then all cured in one final stage, reducing CO₂ emissions by up to 10 kg per vehicle.

Approximately/about +/−2% when the total concentration of the relevant component is above 5%, and +/−0.2% when the total concentration of the relevant component is at or below 5%, and +/−0.05% when the total concentration of the relevant component is at or below 0.1%.

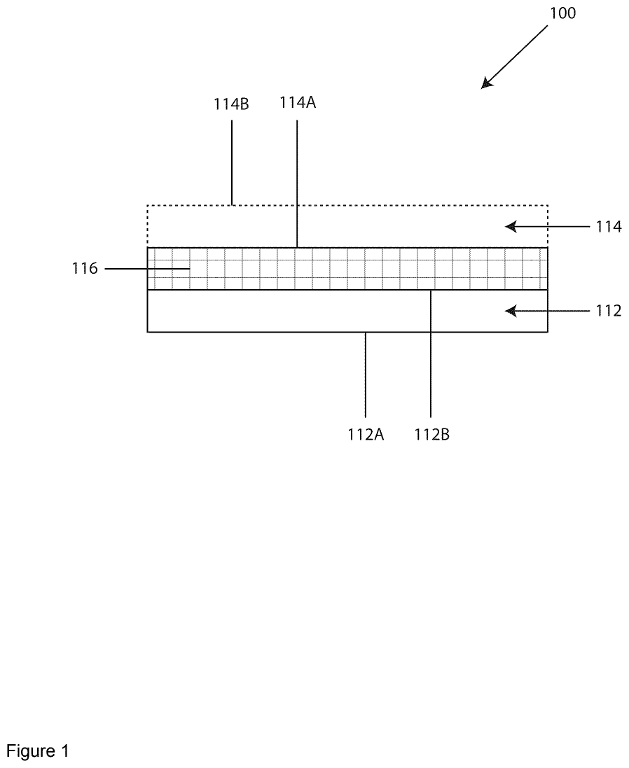

Referring now to the drawings, and to FIG. 1 in particular, component assembly 100 is shown, which generally comprises first substrate 112 having first surface 112A and second surface 112B, optional second substrate 114 having first surface 114A and second surface 114B, and lightweight hybrid plastisol composition 116. It will be understood that component assembly 100 may comprise, for illustrative purposes only, a vehicle component or portion thereof (e.g., a seam sealer for door panels, hood, and interior joints, a roof ditch filler for vehicle roof channels, and/or and underbody coating for protection against chipping and corrosion. Indeed, the compositions of the present invention are suitable for a plurality of applications.

First substrate 112 may be fabricated from any one of a number of materials, such as, for example, steel, steel electrogalvanized with zinc, steel hot dipped galvanized with zinc, aluminum, metal alloys, d-block metals, and combinations thereof. First substrate 112 is preferably fabricated from a sheet having a thickness ranging from approximately 0.25 mm to approximately 5.00 mm, and more preferably ranging from approximately 0.75 mm to approximately 2.50 mm. Of course, the thickness of the substrate will depend largely upon the particular application of the assembly. While particular substrate materials have been disclosed, for illustrative purposes only, it will be understood that numerous other substrate materials are likewise contemplated for use-so long as the materials exhibit appropriate physical properties, such as strength, to be able to operate effectively in conditions of intended use. Indeed, substrate assemblies in accordance with the present invention can be, during normal operation, exposed to extreme temperature variation, as well as substantial UV radiation, emanating primarily from the sun.

Optional second substrate 114 may be fabricated from similar and/or dissimilar materials as that of first substrate 112. Second substrate 114 is preferably fabricated from a sheet having a thickness ranging from approximately 0.25 mm to approximately 5.00 mm, and more preferably ranging from approximately 0.75 mm to approximately 2.50 mm.

### Composition Overview

### PVC Resins

The compositions of the present invention include a strategically formulated blend of polyvinyl chloride (PVC) homopolymer, PVC copolymer, and PVC terpolymer resins, carefully selected and proportioned to achieve an strategic balance of processing and performance characteristics. This synergistic combination of polymeric components enables precise control over critical properties including fusion speed during processing, mechanical strength in the final product, and adhesion to various substrate materials. The deliberate incorporation of these distinct PVC variants, each contributing its unique molecular architecture and resultant property profile, allows for tailored performance that cannot be achieved through the use of any single PVC resin type.

### Polyvinyl Chloride (PVC) Homopolymer Resins

In a preferred embodiment of the present invention, the compositions include one or more PVC homopolymers. The PVC homopolymer employed in the invention consists exclusively of polymerized vinyl chloride monomers, represented by the chemical structure (—CH₂—CHCl—)ₙ, wherein the polymer chains exhibit a uniform molecular architecture devoid of comonomer units. This homogeneity in chemical composition contributes significantly to the distinctive performance characteristics of the resulting composition.

The PVC homopolymer incorporated within the inventive composition preferably possesses a molecular weight distribution predominantly within the range of 60,000 to 200,000 daltons, a range specifically selected to optimize the rheological and mechanical properties required for the intended application. This carefully controlled molecular weight profile ensures proper processing characteristics while maintaining the requisite structural integrity in the final product. The homopolymer's inherent rigidity, arising from the stereoregular arrangement of chlorine atoms along the polymer backbone, imparts exceptional dimensional stability to the composition under varying environmental conditions.

In the formulation of the composition, the PVC homopolymer constitutes approximately 5 to approximately 30 percent by weight of the total composition and more preferably approximately 15 to approximately 20 percent by weight of the total composition, an amount determined to be suitable for balancing processability with performance requirements. At this concentration, the homopolymer provides a robust polymeric framework that confers superior mechanical strength and durability to the composition. The absence of comonomer units in this polymer chain ensures consistent performance characteristics throughout the material, eliminating potential weak points that might otherwise compromise long-term stability.

Non-limiting examples of PVC homopolymers for use in accordance with the present invention include: Vinnolit® series manufactured by Shin-Etsu Chemical Co., Ltd., which are characterized by their controlled particle morphology and precise molecular weight distribution optimized for plastisol applications; Formolon® PVC homopolymers produced by Formosa Plastics Corporation, valued for their excellent mechanical strength and minimal residual vinyl chloride monomer content; EasySoft™ PVC homopolymers supplied by Westlake Chemical Corporation, featuring tailored particle size distribution specifically engineered for superior flow properties in complex formulations; Pevikon® series from INEOS Chlor, recognized for their exceptional batch-to-batch consistency and purity profile suitable for highly regulated applications; Primex® PVC homopolymers manufactured by Orbia (formerly Mexichem), available in various K-values to address specific processing and performance requirements; Kane Ace® PVC homopolymers offered by Kaneka Corporation, with precisely controlled particle morphology facilitating excellent dispersion characteristics; LG PVC series produced by LG Chem, engineered to provide outstanding thermal stability and color retention under demanding processing conditions; OxyVinyls™ PVC homopolymers from Occidental Chemical Corporation (OxyChem), available in various grades with different porosity profiles and molecular weights; TPC PVC homopolymers manufactured by Thai Plastic and Chemicals PCL, known for their consistent bulk density and particle size distribution; and Zhongtai PVC homopolymers supplied by Xinjiang Zhongtai Chemical Co., Ltd., which demonstrate excellent electrical insulation properties particularly suitable for specialized applications.

### PVC Copolymer Resins

The composition according to one embodiment of the present invention comprises a polyvinyl chloride (PVC) copolymer as an integral polymeric component. The PVC copolymer is characterized as a polymeric material formed through the copolymerization of vinyl chloride monomer with a secondary comonomer, preferably vinyl acetate. The resulting macromolecular structure incorporates both monomeric units in a predominantly random distribution along the polymer backbone.

The PVC copolymer of the present invention preferably comprises approximately 93 percent to approximately 97 percent by weight vinyl chloride units and approximately 3 percent to approximately 7 percent by weight vinyl acetate units. This specific compositional range imparts distinct physicochemical properties that differentiate the copolymer from conventional PVC homopolymer. The incorporation of vinyl acetate units into the predominantly vinyl chloride polymer chain disrupts the crystallinity of the resultant polymer, thereby lowering the fusion temperature relative to PVC homopolymer. This modification to the thermal profile facilitates processing at reduced temperatures, which may confer advantages in terms of energy efficiency and thermal stability during fabrication operations.

The presence of the vinyl acetate moieties within the copolymer structure enhances chain mobility and reduces intermolecular forces, resulting in improved flexibility characteristics. Additionally, the polar acetate groups contribute to enhanced adhesion properties, particularly with respect to polar substrates. These combined attributes render the PVC copolymer particularly suitable for applications requiring superior substrate adhesion and moderate flexibility without substantial compromise of mechanical integrity.

In the formulation according to the present invention, the PVC copolymer constitutes approximately 5 to approximately 30 percent by weight of the total composition, and more preferably approximately 10 to approximately 20 percent by weight of the total composition. At this loading level, the copolymer effectively modifies the processing characteristics of the composition while providing the requisite adhesion to targeted substrate materials.

Non-limiting examples of commercial PVC copolymer sources include, but are not limited to: Vinnolit GmbH & Co. KG, which produces the Vinnolit E series of vinyl chloride-vinyl acetate copolymers with specified vinyl acetate content within the claimed range; Kaneka Corporation, offering the Kaneka VPAC series specifically designed for enhanced adhesion applications; Occidental Chemical Corporation (OxyChem), which manufactures specialized vinyl chloride copolymers under their OxyVinyl trade designation; Shin-Etsu Chemical Co., Ltd., providing PVC copolymers with controlled vinyl acetate content for specialty applications; Formosa Plastics Corporation, which produces vinyl chloride-vinyl acetate copolymers with tailored rheological properties; LG Chem Ltd., offering the LG-PVCVA series with specific vinyl acetate incorporation rates; Westlake Chemical Corporation, which manufactures copolymers with the requisite vinyl acetate content for specialty applications; Thai Plastic and Chemicals Public Company Limited (TPC), providing vinyl chloride copolymers suitable for adhesion-critical formulations; and Mitsubishi Chemical Corporation, which offers specially engineered PVC copolymers with controlled vinyl acetate content.

### PVC Terpolymer Resins

The compositions of the present invention further incorporate a PVC terpolymer as a preferred polymeric constituent. This sophisticated terpolymer comprises three distinct monomeric units strategically copolymerized to yield a multifunctional polymeric material with enhanced performance characteristics. Specifically, the PVC terpolymer preferably contains approximately 94.5% vinyl chloride units, 2.75% hydroxyethyl acrylate units, and 2.75% vinyl acetate units by weight. This precise compositional profile has been determined to provide suitable property enhancement when incorporated within the broader polymeric matrix of the invention.

In the formulation according to the present invention, the PVC terpolymer constitutes approximately 2 to approximately 30 percent by weight of the total composition and more preferably approximately 5 to approximately 15. At this loading level, the terpolymer effectively contributes its distinctive attributes without compromising other essential properties of the formulation. The incorporation of hydroxyethyl acrylate moieties introduces reactive hydroxyl functionality along the polymer backbone, significantly enhancing interfacial interactions and promoting compatibility with diverse formulation components. Meanwhile, the vinyl acetate units contribute additional polarity and flexibility to the terpolymer structure.

The synergistic combination of these carefully selected comonomers within the predominantly vinyl chloride polymer chain results in markedly improved compatibility characteristics and superior adhesion properties when compared to conventional PVC homopolymers or simple copolymers. The presence of the hydroxyl-functional acrylate groups is particularly advantageous for promoting adhesion to challenging substrate materials, including metals, ceramics, and various polymeric surfaces, through hydrogen bonding and potential chemical interaction mechanisms. This enhanced substrate affinity makes the PVC terpolymer an valuable component for applications requiring robust interfacial adhesion across diverse material interfaces.

Non-limiting examples of commercially available PVC Terpolymers suitable for use in the present invention, include but are not limited to: Solvay Specialty Polymers, which produces the Solvin® HT series incorporating hydroxyethyl acrylate functionality for enhanced adhesion applications; Shin-Etsu Chemical Co., Ltd., offering the VYHH-HEA series of terpolymers with precise control of hydroxyethyl acrylate and vinyl acetate content; Sekisui Chemical Co., Ltd., which manufactures specialized vinyl chloride terpolymers under their S-TEC™ designation; Kaneka Corporation, providing custom-engineered terpolymers with controlled hydroxyl functionality for specialty applications; Formosa Plastics Corporation, which produces vinyl chloride-based terpolymers with tailored functional group distribution; INEOS Compounds, offering the INCOS® HA series with specific hydroxyethyl acrylate incorporation rates; and Westlake Chemical Corporation, which manufactures terpolymers with the requisite functional monomer content for specialty adhesion applications.

### Plasticizers

The compositions of the present invention preferably incorporate a carefully selected mixture of plasticizers at a concentration from approximately 10 to approximately 50 percent by weight of the total composition and more preferably from approximately 20 to approximately 35. This substantial plasticizer loading is important for achieving the desired rheological, thermal, and mechanical properties of the final composition. The plasticizers function primarily by intercalating between polymer chains, thereby reducing intermolecular forces, increasing free volume, and consequently lowering the glass transition temperature (Tg) of the polymeric system. This modification of the viscoelastic properties imparts enhanced flexibility to the composition while simultaneously facilitating fusion processing at temperatures ranging from 110-190° C.

The plasticizer component comprises a strategic combination of complementary plasticizer types, selected to provide an optimal balance of solvating efficiency, permanence, and compatibility with the PVC polymer blend. Diisononyl phthalate (DINP) serves as a primary plasticizer, providing excellent compatibility with PVC and contributing substantial flexibility. Benzoate esters, particularly dibenzoate esters of 2,2,4-trimethyl-1,3-pentane diol, are incorporated as preferred benzoate plasticizers due to their superior fusion promotion characteristics and favorable environmental profile. Additionally, specialized plasticizers such as benzyl 3-isobutyrloxy-1-isopropyl-2,2-dimethylpropyl phthalate contribute unique solvating properties that enhance the overall plasticization efficiency of the system. The synergistic interaction between these carefully selected plasticizers and the polymeric components results in a composition that exhibits excellent fusion characteristics at the specified processing temperature range while maintaining the requisite flexibility and mechanical integrity in the final application.

In a preferred embodiment of the present invention, the plasticizers comprise compounds represented by the following chemical structures and derivatives thereof:

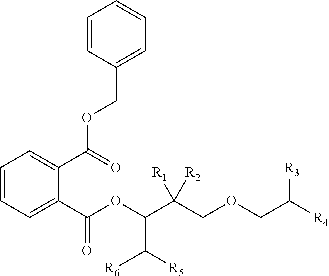

wherein R₁-R₆ are the same or different and comprise H; OH; an alkyl, cycloalkyl, polycycloalkyl, heterocycloalkyl, aryl, alkaryl, aralkyl, alkoxy, alkanoyl, aroyl, alkenyl, alkynyl and/or cyano group containing approximately 1 to approximately 25 carbon atom(s).

In another preferred embodiment of the present invention, the plasticizers comprise one or more compounds represented by the following chemical structures:

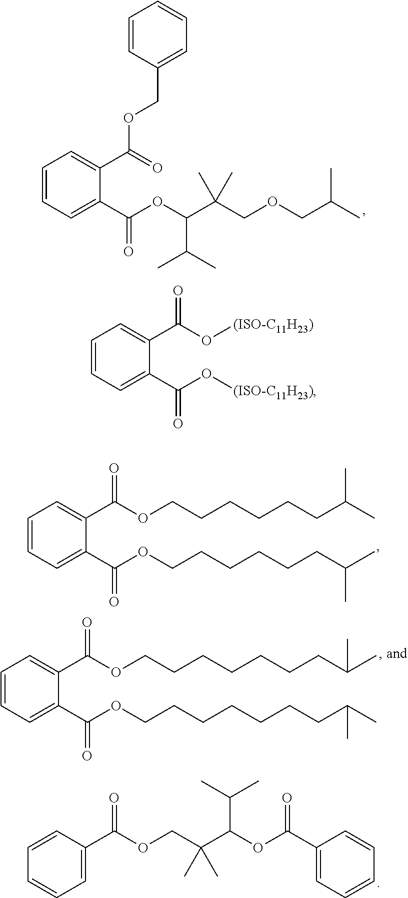

Non-limiting examples of commercially available plasticizers, include but are not limited to: ExxonMobil Chemical, which produces Jayflex™ DINP (diisononyl phthalate) with controlled isomer distribution for optimal compatibility with PVC systems; BASF SE, offering Palatinol® N (diisononyl phthalate) and specialized benzoate ester plasticizers for enhanced processing characteristics; Eastman Chemical Company, which manufactures Benzoflex™ series of benzoate plasticizers, including dibenzoate esters of 2,2,4-trimethyl-1,3-pentane diol under the trade name Benzoflex™ 354; Emerald Kalama Chemical, providing K-Flex® benzoate plasticizers with superior fusion promotion properties; Perstorp Holding AB, which produces Pevalen™ non-phthalate plasticizers compatible with the present composition; Lanxess AG, offering Unimoll® plasticizers suitable for specialized PVC applications; Velsicol Chemical LLC, which manufactures Benzoflex® 2088 and related benzoate plasticizers specifically designed for PVC fusion applications; and UPC Technology Corporation, providing Sunplast™ DINP and specialty phthalate plasticizers with controlled molecular structure for enhanced performance.

### Adhesion Promoters

The compositions of the present invention preferably incorporate blocked isocyanate adhesion promoters as an important functional component, constituting approximately 0.5 to approximately 30 percent by weight of the total composition, and more preferably approximately 1 to approximately 15 percent by weight of the total formulation. These specialized adhesion-enhancing additives plays a pivotal role in establishing robust interfacial bonding between the polymeric matrix and challenging substrate materials, particularly electrocoat (E-coated) substrates commonly encountered in automotive and industrial applications. The blocked isocyanate, preferably comprising an aliphatic polyisocyanate structure, remains chemically inert under ambient conditions due to the presence of blocking groups that temporarily mask the reactive isocyanate moieties.

Upon exposure to elevated temperatures during the processing or curing phase, typically within the range of 130-180° C., the blocking groups dissociate from the isocyanate functionality, thereby regenerating the highly reactive isocyanate groups. These activated isocyanate moieties subsequently participate in crosslinking reactions with nucleophilic functional groups present at the substrate interface, including hydroxyl, amino, and carboxyl functionalities commonly found on E-coated surfaces. This thermally-triggered reaction mechanism enables the formation of covalent chemical bonds across the polymer-substrate interface, significantly enhancing adhesion strength and durability.

A particularly advantageous characteristic of the blocked isocyanate adhesion promoters employed in the present invention is their compatibility with acid-catalyzed topcoat systems. Unlike conventional adhesion promoters that may interfere with subsequent coating applications, the blocked isocyanate component maintains its adhesion-enhancing functionality without disrupting the chemistry of acid-catalyzed topcoats that may be applied in multi-layer coating systems. This selective reactivity profile enables the composition to function effectively within complex coating architectures while preserving the integrity of each functional layer.

Non-limiting examples of commercially available blocked isocyanate adhesion promoters, include but are not limited to: Covestro AG, which produces Desmodur® BL series of blocked polyisocyanates, specifically designed for adhesion promotion in polymer systems; BASF SE, offering Basonat® blocked aliphatic polyisocyanates with controlled deblocking temperatures; Evonik Industries AG, which manufactures Vestanat® blocked isocyanates with enhanced compatibility in PVC systems; Vencorex Chemicals, providing Tolonate™ HDT-LV2 and related blocked aliphatic polyisocyanates with optimized reactivity profiles; Wanhua Chemical Group Co., Ltd., which offers Wannate® BL series of blocked isocyanates specifically formulated for adhesion to E-coated substrates; Asahi Kasei Corporation, manufacturing Duranate™ blocked polyisocyanates with superior thermal stability characteristics; Allnex, which produces Cymel® XI-203 and related blocked isocyanate crosslinkers compatible with various polymer systems; and Huntsman Corporation, offering Suprasec® blocked MDI derivatives with tailored deblocking temperatures for specific processing conditions.

### Filler Components

The compositions of the present invention incorporate a strategic combination of functional fillers, specifically coated calcium carbonate and hollow glass microspheres, each contributing distinct and complementary properties to the overall formulation.

### Coated Calcium Carbonate

The compositions of the present invention preferably comprise coated calcium carbonate ranging from approximately 2 to approximately 30 percent by weight of the total composition, and more preferably ranging from approximately 5 to approximately 15 percent by weight of the total formulation. Coated calcium carbonate is a multifunctional filler that serves several important roles within the formulation. The calcium carbonate particles are surface-treated with stearic acid or similar fatty acid derivatives, which enhances their compatibility with the polymeric matrix while preserving their functional benefits. This surface modification reduces the surface energy of the calcium carbonate particles, thereby improving their dispersion characteristics within the polymeric system and preventing undesirable agglomeration during processing.

The primary function of the coated calcium carbonate is to impart controlled thixotropic properties to the composition. The fine, irregular particles create a three-dimensional network structure within the polymeric matrix, resulting in shear-thinning rheological behavior that is particularly advantageous during application. This thixotropic characteristic significantly enhances sag resistance in vertical and overhead applications, enabling the deposition of uniform, controlled-thickness coatings on complex substrate geometries without undesirable flow or dripping phenomena. Additionally, the calcium carbonate component contributes to improved impact resistance and cost efficiency in the final formulation.

### Hollow Glass Microspheres

The compositions of the present invention preferably incorporate hollow glass microspheres ranging in concentration from approximately 2 to approximately 30 percent by weight of the total composition, and more preferably from approximately 5 to approximately 15. The hollow glass microspheres constitute a significant lightweight reinforcing filler component. These spherical, thin-walled glass particles possess a precisely controlled particle size distribution within the range of 15-50 microns, with a remarkably low density of 0.25-0.40 g/cc. The hollow glass microspheres exhibit exceptional compressive strength, ranging from 5,000-16,000 psi, which enables them to withstand the shear forces encountered during processing while maintaining their structural integrity.

The incorporation of these hollow glass microspheres serves multiple functional purposes within the composition. Most significantly, they contribute to substantial weight reduction in the final product, with density reductions of up to 30% compared to formulations utilizing conventional solid fillers. This weight reduction is particularly valuable in automotive, aerospace, and transportation applications where mass reduction translates directly to improved fuel efficiency and performance characteristics. Furthermore, the spherical morphology of these particles imparts improved flow properties during processing, enhancing mold filling characteristics and surface finish quality.

Perhaps most importantly, the hollow glass microspheres significantly enhance the chip resistance of the cured composition. Upon impact, these microspheres function as energy-absorbing elements, effectively dissipating impact forces throughout the polymeric matrix rather than allowing stress concentration and consequent crack propagation. This mechanism substantially improves the resistance of the final product to stone chipping, abrasion, and similar mechanical damage commonly encountered in automotive and industrial applications.

The fillers suitable for use in the present invention may be obtained from various commercial sources, including but not limited to: for coated calcium carbonate: Omya AG, which produces Omyacarb® surface-treated calcium carbonates with controlled particle size distributions; Imerys Performance Minerals, offering Calcipur® stearate-coated calcium carbonates specifically designed for polymer applications; Huber Engineered Materials, which manufactures Hubercarb® W series of surface-modified calcium carbonates; Mississippi Lime Company, providing ViCALity® coated ground calcium carbonates with enhanced dispersibility; and Minerals Technologies Inc., which offers Vicron® and Ultracarb® treated calcium carbonates with tailored surface chemistry; and for hollow glass microspheres: 3M Company, which produces 3M™ Glass Bubbles K series with various density and crush strength specifications within the claimed ranges; Potters Industries LLC, offering Sphericel® hollow glass microspheres with controlled particle size distributions; Trelleborg Applied Technologies, providing Eccospheres® lightweight hollow glass microspheres for polymer applications; Nanjing Jianzun Glass Microsphere Co., Ltd., which manufactures JZ series hollow glass microspheres with specified crush strengths; and Sinosteel Maanshan New Material Technology Co., Ltd., offering Microball™ hollow glass microspheres with tailored density and mechanical properties.

### Solvent Component

The compositions of the present invention preferably incorporate a solvent component (e.g., odorless mineral spirits), constituting approximately 0.5 to approximately 20 percent by weight of the total composition, and more preferably approximately 1 to approximately 10 percent by weight of the total formulation. This controlled solvent addition serves important functions in modulating the rheological properties of the composition, particularly with respect to application characteristics and flow behavior.

The odorless mineral spirits employed in the present invention are characterized by a flash point within the range of 60-70° C., representing a balance between processability and safety considerations. This moderately high flash point ensures that the composition exhibits favorable handling characteristics while minimizing flammability hazards during storage, transportation, and application. The solvent comprises predominantly aliphatic hydrocarbon constituents that have undergone specialized refining processes to remove aromatic compounds and sulfur-containing species, thereby yielding a low-odor profile that enhances workplace acceptability and reduces potential environmental concerns.

The primary function of the solvent component is to provide precise control over the viscosity profile of the composition, particularly during application processes. The inclusion of the solvent at the specified concentration range facilitates optimal sprayability characteristics, enabling the composition to be effectively atomized and deposited as a uniform coating when applied via conventional or electrostatic spray equipment. This enhanced sprayability translates to improved transfer efficiency, reduced material waste, and superior surface finish quality in the final application. Additionally, the controlled evaporation rate of the odorless mineral spirits contributes to appropriate flow and leveling properties, allowing the applied composition to achieve optimal substrate wetting while maintaining sufficient resistance to sagging on vertical or complex surfaces.

It is noteworthy that the solvent component is designed to evaporate completely during the subsequent curing process, leaving the final polymeric matrix essentially free of residual solvent. This evaporation occurs in a controlled manner that prevents surface defects such as pinholes or blistering while enabling the development of optimal mechanical and adhesion properties in the cured composition. The relatively narrow concentration range of 1-10% by weight represents an optimization between processing requirements and environmental considerations, minimizing volatile organic compound (VOC) emissions while maintaining essential application characteristics.

The odorless mineral spirits suitable for use in the present invention may be obtained from various commercial sources, including but not limited to: ExxonMobil Chemical, which produces Exxsol™ D series of low-aromatic hydrocarbon fluids with controlled evaporation rates; Shell Chemicals, offering ShellSol™ D series of dearomatized aliphatic solvents with specified flash point ranges; Chevron Phillips Chemical Company, which manufactures Soltrol® hydrocarbon solvents with tailored distillation profiles; Total Energies, providing Spirdane™ D series of odorless mineral spirits with controlled aromatic content; Idemitsu Kosan Co., Ltd., which offers Isopar™ series of isoparaffinic hydrocarbon solvents with low odor characteristics; Neste Corporation, manufacturing Nexbase™ series of highly refined hydrocarbon fluids suitable for polymer applications; and SK Geo Centric Co., Ltd., providing SK-Sol™ series of odorless mineral spirits with specified flash point characteristics.

### Additive Components

The compositions of the present invention incorporate a carefully selected array of functional additives, each present at concentrations of approximately 0.1-2% by weight of the total formulation. These additives, while representing relatively minor constituents by mass, exert substantial influences on processing characteristics, chemical stability, and application performance of the composition.

Calcium oxide is incorporated as an effective moisture scavenging agent, serving to sequester residual water molecules that may be present within the formulation or introduced during processing operations. This hygroscopic compound reacts with water to form calcium hydroxide, thereby preventing moisture-induced degradation of the blocked isocyanate adhesion promoter and other moisture-sensitive components. The presence of calcium oxide significantly enhances the storage stability of the composition and ensures consistent performance characteristics across varying environmental conditions.

Zinc oxide functions as a primary stabilizer within the composition, providing multiple stabilization mechanisms that protect the PVC polymer system against thermal and oxidative degradation. This amphoteric metal oxide acts as a hydrogen chloride scavenger, neutralizing acidic degradation products that would otherwise catalyze further dehydrochlorination of the polymer chains. Additionally, zinc oxide contributes to long-term heat stability during both processing and service life, thereby maintaining the mechanical integrity and appearance characteristics of the final product.

Zinc octoate is integrated into the formulation as a specialized catalyst, specifically designed to facilitate the deblocking reaction of the isocyanate prepolymer adhesion promoter. At elevated processing temperatures, this organometallic compound accelerates the dissociation of the blocking groups from the isocyanate functionalities, thereby enhancing the rate and efficiency of the adhesion-promoting reactions at the substrate interface. The controlled catalytic activity of zinc octoate ensures optimal adhesion development while maintaining compatibility with the overall formulation chemistry.

Fumed silica serves as a critical rheology modifier within the composition, comprising nanoscale silica particles with extremely high surface area. These particles form a three-dimensional network structure through hydrogen bonding interactions, imparting thixotropic characteristics to the formulation. This rheological behavior significantly enhances application properties, including sag resistance on vertical surfaces, controlled flow characteristics, and prevention of pigment settling during storage. The incorporation of fumed silica enables precise control over application viscosity while maintaining excellent leveling properties after deposition.

The composition may optionally include titanium dioxide as a white pigment and opacifier, providing both aesthetic qualities and enhanced ultraviolet light protection. Additionally, specialized ultraviolet light stabilizers, comprising hindered amine light stabilizers (HALS) and/or benzotriazole derivatives, may be incorporated to extend the service lifetime of the composition in exterior exposure applications. Biocides, typically comprising isothiazolinone derivatives or pyrithione compounds, may be included to prevent microbial degradation during storage and to protect the final product against fungal and algal growth in high-humidity environments.

### Non-Limiting Examples of Commercial Additive Sources

The functional additives suitable for use in the present invention may be obtained from various commercial sources, including but not limited to: Mississippi Lime Company, which produces high-purity calcium oxide with controlled reactivity characteristics; U.S. Zinc, offering French Process zinc oxide with specified particle size distributions for polymer applications; Evonik Industries AG, which manufactures Aerosil® fumed silica with tailored surface chemistry; Dura Chemicals, Inc., providing zinc octoate catalysts with controlled metal content; Kronos Worldwide, Inc., which produces Kronos® titanium dioxide grades specifically designed for polymer applications; BASF SE, offering Tinuvin® ultraviolet light stabilizers with synergistic stabilization mechanisms; Dow Inc., which manufactures DOWICIL™ and BIOBAN™ antimicrobial preservatives; and Troy Corporation, providing Troysan™ biocides with broad-spectrum effectiveness.

### Optional Epoxy Resins

The compositions of the present invention may optionally include one or more epoxy resins to enhance curing stability and compatibility with the polymeric matrix during the thermal processing stage. A preferred epoxy resin is diglycidyl ether of Bisphenol A (DGEBA), a low molecular weight epoxy resin derived from the reaction of Bisphenol A and epichlorohydrin, characterized by its epoxide functional groups that contribute to crosslinking and stabilization at curing temperatures of 110-190° C. DGEBA, when included, is typically present in an amount ranging from 0 to 5 percent by weight of the total composition, with a preferred range of approximately 1 to 2 percent by weight, as exemplified in certain embodiments. Other suitable epoxy resins may include diglycidyl ether of Bisphenol F (DGEBF) or higher molecular weight epoxy resins, which provide similar stabilizing effects. The incorporation of such epoxy resins enhances the composition's thermal stability and durability, particularly in automotive paint shop applications, without compromising the lightweight properties achieved through the hollow glass microspheres and PVC resin blend. Commercial sources of DGEBA include, but are not limited to, EPON™ Resin 828 from Hexion Inc., D.E.R.™ 331 from Olin Corporation, and Araldite® GY 6010 from Huntsman Corporation, each offering consistent epoxide equivalent weights suitable for plastisol formulations.

It is to be understood that while specific commercial sources have been identified herein, the present invention is not limited to materials obtained from these particular suppliers. Other sources providing additives meeting the functional specifications delineated herein may be equally suitable for implementation of the present invention. Furthermore, the specific combination and concentration of components may be adjusted within the general ranges specified to optimize performance for particular application requirements, substrate materials, or processing conditions.

### Preparation Method

The composition of the present invention is prepared through a carefully sequenced multi-stage process designed to ensure optimal component distribution, homogeneity, and performance characteristics in the final product.

In the initial phase of preparation, the plasticizers and base polymer (exemplified by Uniseal AAB01P0286) are introduced into a suitable mixing vessel equipped with variable-speed impellers capable of providing controlled shear conditions. These components are subjected to medium-speed agitation, typically 800-1200 RPM, for a period of approximately 15 minutes. This moderate shear regime facilitates the initial solvation of the polymer by the plasticizer components while preventing excessive heat generation that could potentially compromise thermal stability. The resulting mixture exhibits a homogeneous appearance with the plasticizers thoroughly incorporated throughout the polymeric matrix.

Following this initial blending stage, the various polyvinyl chloride resins, including the PVC homopolymer, copolymer, and terpolymer components, are gradually introduced into the vessel while maintaining constant agitation. The incorporation process continues until complete homogeneity is achieved, as evidenced by the absence of visible resin particles and the development of a uniform consistency throughout the mixture. This stage typically requires 20-30 minutes of mixing time, with the exact duration dependent on batch size and equipment characteristics.

The third stage involves the sequential addition of the functional fillers (excluding the hollow glass microspheres), stabilizers, and the blocked isocyanate adhesion promoter. These components are incorporated while increasing the mixing speed to a high-shear condition, typically 1500-2000 RPM, which is maintained for approximately 20 minutes. This elevated shear regime ensures thorough dispersion of the particulate components throughout the polymeric matrix while activating the surface treatments on the calcium carbonate filler. The high-energy mixing conditions facilitate optimal distribution of the stabilizers and adhesion promoter, ensuring their availability throughout the composition.

In the subsequent phase, the hollow glass microspheres and rheology modifier (fumed silica) are carefully introduced under controlled conditions to prevent damage to these shear-sensitive components. The mixing speed is reduced to a moderate level, typically 600-900 RPM, and maintained for approximately 10 minutes. This gentler mixing regime allows for thorough incorporation of these components while preserving the structural integrity of the hollow glass microspheres, which is critical for achieving the desired density reduction and mechanical properties in the final product.

The fifth stage involves the addition of the odorless mineral spirits solvent and any biocidal components. Following introduction of these final ingredients, the entire composition is subjected to vacuum conditions of approximately 25-28 inHg while continuing agitation at reduced speed (300-500 RPM) for approximately 45 minutes. Throughout this vacuum mixing stage, the temperature is maintained at approximately 30° C. through jacketed cooling of the vessel. This combination of vacuum treatment and controlled temperature facilitates the removal of entrapped air, providing a composition that is essentially free of voids that could compromise application characteristics or final performance.

Following completion of the active mixing phases, the composition is allowed to stabilize for a period of 8-10 hours under quiescent conditions. This stabilization period permits the relaxation of internal stresses within the polymeric matrix and allows for the completion of any slow interactions between components. Finally, the composition is filtered through an appropriate media, typically a 60-100 mesh screen, to remove any potential contamination or agglomerates, yielding a finished product with consistent performance characteristics and application properties.

### Key Performance Properties

The compositions of the present invention exhibit a distinctive profile of physicochemical and mechanical properties that collectively enable superior performance in automotive and industrial sealing applications. These performance characteristics have been systematically evaluated through standardized testing methodologies to ensure consistent quality and functional reliability.

The composition demonstrates carefully controlled rheological properties, with a viscosity of approximately 60-70 Pa·s when measured at 25° C. using a controlled-stress rheometer with parallel plate geometry. This viscosity profile represents an optimal balance between processing requirements and application characteristics, enabling efficient dispensing while maintaining positional stability after application.

Adhesion performance, a critical parameter for sealing applications, is exemplified by overlap shear strength values of 2.0-3.0 MPa when applied to electrocoated (E-coated) metal substrates and tested according to ASTM D1002. This robust adhesion to E-coated substrates is particularly significant for automotive applications where integration with modern vehicle manufacturing processes is essential.

The composition exhibits exceptional mechanical flexibility, with elongation values of 70-90% when tested according to ASTM D412. This elongation capacity enables the sealant to accommodate differential thermal expansion and contraction between joined substrates, as well as vibration and structural flexing during service. Complementing this flexibility, the composition maintains a tensile strength of 1.5-2.0 MPa, providing sufficient cohesive integrity for long-term durability in demanding applications.

Channel flow characteristics, evaluated through standardized roof ditch testing, demonstrate controlled flow distances of 25-300 mm depending on specific formulation parameters and application conditions. This controlled flow behavior enables effective sealing of complex joint geometries while maintaining precise positional control.

The composition can be effectively cured under a range of thermal conditions, from 110° C. to 190° C., with corresponding cure times ranging from 60 minutes at the lower temperature boundary to 10 minutes at the upper temperature limit. This processing flexibility permits integration with various manufacturing protocols, including energy-efficient reduced-temperature curing cycles.

Abrasion resistance is exemplified by the absence of significant chipping or material loss after exposure to 300 liters of gravel impact, tested according to SAE J400 protocols. This exceptional impact resistance ensures maintenance of sealing integrity in environments subject to stone chipping and abrasive media.

The composition demonstrates comprehensive compatibility with modern automotive coating systems, including conventional solvent-based systems, three-wet (3-wet) consolidated processes, and four-wet (4-wet) integrated coating technologies. This broad compatibility spectrum enables seamless integration with evolving automotive manufacturing methodologies without compromising performance or appearance characteristics.

### Advantages Over Conventional Sealants

The compositions of the present invention offer substantial advantages over conventional automotive sealant technologies, delivering benefits across manufacturing, performance, and sustainability domains.

A primary advantage is the significantly reduced density of approximately 0.75 g/cc, compared to conventional sealants with densities of 1.45-1.55 g/cc. This density reduction translates directly to weight savings of approximately 1% per vehicle, a considerable contribution to overall vehicle mass reduction strategies. This weight reduction, in turn, contributes to improved fuel efficiency, with testing demonstrating fuel economy improvements of 10-15% attributable to comprehensive weight reduction programs incorporating the present composition.

The present invention enables substantial manufacturing process simplification through its versatility. Whereas conventional approaches often require three distinct sealant products for different vehicle applications, the present composition provides equivalent or superior performance across all application zones, enabling consolidation to a single product. This consolidation reduces inventory requirements, simplifies logistics, and eliminates potential application errors associated with product selection.

The composition exhibits superior performance in modern paint processes, including enhanced compatibility with high-temperature zones in paint ovens and improved resistance to solvent exposure during subsequent coating operations. This compatibility with contemporary automotive coating technologies enables seamless integration with evolving manufacturing methodologies without compromising performance or appearance characteristics.

Environmental advantages accrue from the composition's compatibility with energy-efficient paint processes, including reduced-temperature curing cycles and consolidated coating applications. These efficiencies contribute to reduced carbon dioxide emissions in the manufacturing process, with documented reductions of approximately 12-18% compared to conventional systems requiring higher temperatures and extended curing periods.

Additionally, the composition maintains excellent low-temperature flexibility, with retained elastomeric properties at temperatures as low as −40° C., ensuring sealing integrity in cold-climate applications. Weathering resistance, evaluated through accelerated testing according to SAE J2527, demonstrates exceptional resistance to degradation from ultraviolet exposure, moisture cycles, and temperature fluctuations, thereby ensuring long-term performance throughout the vehicle service life.

These combined advantages position the present invention as a significant advancement in automotive sealing technology, delivering tangible benefits across manufacturing efficiency, vehicle performance, and environmental sustainability parameters.

### Component Ratios and Distinctive Features

In one embodiment of the present invention, specific ratios of PVC polymers may contribute to its performance characteristics. For example, the ratio of PVC homopolymer to PVC copolymer may preferably range from approximately 1:0.5 to 1:1.3, and in certain implementations more preferably from approximately 1:0.7 to 1:1.1. Similarly, the ratio of PVC homopolymer to PVC terpolymer may advantageously range from approximately 1:0.25 to 1:1, and in some embodiments more preferably from approximately 1:0.3 to 1:0.75. Such trimodal polymer systems can establish a balanced distribution of mechanical properties that may contribute to the composition's performance profile.

According to certain aspects of the present invention, the plasticizer components may be incorporated in ratios that can optimize both processing characteristics and final performance. In some implementations, the ratio of phthalate-based plasticizers to benzoate-based plasticizers could range from approximately 1:0.7 to 1:1.3, and optionally from approximately 1:0.9 to 1:1.1. In certain embodiments, the proportion of benzyl 3-isobutyrloxy-1-isopropyl-2,2-dimethylpropyl phthalate relative to total plasticizer content may be maintained between approximately 0.2:1 and 0.3:1. These ratios can enable balanced fusion characteristics and flexibility in the composition.

In various implementations, the ratio between the coated calcium carbonate filler and the hollow glass microspheres may influence both rheological behavior and final density. This ratio could advantageously range from approximately 1:0.8 to 1:1.5, and in some embodiments from approximately 1:1.2 to 1:1.4. At such proportions, the composition may achieve thixotropic characteristics while maintaining density reduction for automotive weight savings. In certain circumstances, when the ratio falls below 1:0.8, density reduction might be compromised, while ratios exceeding 1:1.5 may potentially affect mechanical strength and application characteristics.

One implementation of the present invention may feature a relationship between the blocked isocyanate adhesion promoter and the PVC terpolymer component. The ratio of blocked isocyanate adhesion promoter to PVC terpolymer could advantageously range from approximately 0.2:1 to 1:1, and in some embodiments from approximately 0.4:1 to 0.9:1. Such ratios may help ensure sufficient reactive sites for adhesion promotion without compromising the basic polymeric architecture of the composition. In certain implementations, the hydroxyethyl acrylate functionality in the terpolymer may interact with the blocked isocyanate component at these proportions.

According to some aspects of the invention, the proportion of odorless mineral spirit solvent relative to the total solids content (polymers, fillers, and additives) may influence application characteristics. This ratio could preferably range from approximately 0.05:1 to 0.15:1, and in certain embodiments from approximately 0.07:1 to 0.12:1. When maintained within such boundaries, the composition may exhibit sprayability and flow characteristics while potentially minimizing volatile organic compound (VOC) emissions and facilitating solvent evaporation during the curing process.

In some implementations, the composition may exhibit a multimodal particle size distribution that contributes to packing efficiency and mechanical properties. The hollow glass microspheres may, in certain embodiments, maintain an average particle size of 25-40 microns, while the coated calcium carbonate filler might exhibit a bimodal distribution with peaks at approximately 2-5 microns and 8-12 microns. Such particle size relationships could optimize interstitial filling within the polymeric matrix, potentially enhancing both density reduction and mechanical integrity.

According to certain aspects of the invention, the composition may demonstrate a thermal response profile characterized by a glass transition temperature (Tg) of approximately −35° C. to −25° C. and a fusion onset temperature of approximately 110° C. to 125° C. The difference between these transition points, which could be maintained at 135° C. to 160° C. in some embodiments, may provide the composition with both low-temperature flexibility and thermal stability during processing. Such thermal profiles could distinguish compositions according to the present invention from other compositions.

In some implementations, the composition may exhibit a curing profile defined by the relationship between temperature (T in ° C.) and time (t in minutes) that could be approximated by: t×(T−105)\hat{ }1.5\hat{ }=2,700-3,300. This relationship may enable processing flexibility while helping ensure complete cure across diverse manufacturing environments. Compositions falling within such a processing envelope might demonstrate adhesion development and mechanical property acquisition that could distinguish them from formulations requiring different processing conditions.

According to certain embodiments, the present invention may demonstrate a three-way relationship between the polymeric components, plasticizers, and fillers. For example, the ratio of total PVC polymer content (homopolymer+copolymer+terpolymer) to total plasticizer content to total filler content (coated calcium carbonate+hollow glass microspheres) could range from approximately 5:3:3 to 5:4:4, and in some implementations from approximately 5:3.5:3.5 to 5:3.8:3.8. Such a three-component relationship may establish viscoelastic properties that could distinguish the composition from other formulations with different component distributions.

In certain implementations, a balance may exist between the reactive components within the composition, potentially characterized by the relationship between the hydroxyethyl acrylate functional groups in the PVC terpolymer, the blocked isocyanate moieties in the adhesion promoter, and the zinc octoate catalyst. This relationship might be expressed as a molar ratio of approximately 1.0-1.5:0.8-1.2:0.01-0.05, respectively, in some embodiments. Such a stoichiometric balance could help ensure crosslinking density without compromising flexibility or adhesion. In certain circumstances, deviations from this ratio might result in either insufficient crosslinking or excessive crosslinking.

According to some aspects of the invention, the rheological behavior of the composition may be influenced by a relationship between the PVC copolymer, coated calcium carbonate, fumed silica, and mineral spirit components. The ratio of these components could, in certain embodiments, be maintained at approximately 10-20:5-15:0.1-0.5:1-10 parts by weight, potentially creating a network that exhibits temperature and shear-dependent viscosity characteristics. Such a relationship might enable the composition to remain stable during storage, flow appropriately during application, and resist sag on vertical surfaces.

In some implementations, the composition may achieve its low density through a relationship between the hollow glass microspheres, total plasticizer content, and mineral spirit solvent. This relationship, when expressed as a volumetric ratio, could preferably range from approximately 4:3:1 to 5:3:1 in certain embodiments. When these components are maintained within such a ratio range, the composition might achieve a balance between density reduction and mechanical integrity, potentially enabling a density of 0.7-1.0 g/cc while maintaining mechanical properties comparable to formulations with higher densities.

According to certain aspects of the invention, thermal performance of the composition may depend on a relationship between the PVC homopolymer, calcium oxide, zinc oxide, heat stabilizer, and light stabilizer components. These components could, in some embodiments, maintain a weight ratio of approximately 100:1-3:2-4:5-15:2-6, respectively. Such a stabilization system might provide protection against thermal degradation during processing and environmental exposure during service, potentially enabling the composition to withstand processing temperatures of 110-190° C. while maintaining stability under automotive service conditions.

In certain implementations, the composition may exhibit a relationship between processing characteristics and final properties, potentially governed by the proportion of total PVC resin content to total plasticizer content to adhesion promoter to solvent content. This four-component relationship could, in some embodiments, be maintained at approximately 5:3:1:0.5 parts by weight, potentially creating a balance between application viscosity, cure rate, adhesion development, and final physical properties. In certain circumstances, deviations from this relationship might result in altered performance in one or more parameters.

According to some aspects of the invention, the environmental resistance of the composition may stem from a relationship between the PVC terpolymer content, light stabilizer, heat stabilizer, and calcium oxide components. These components could, in certain embodiments, maintain a weight ratio of approximately 100:10-15:15-20:3-5, respectively. Such a system might provide protection against ultraviolet degradation, oxidative deterioration, and moisture-induced degradation, potentially enabling the environmental resistance demonstrated in accelerated weathering and Florida exposure testing.

In certain implementations, the chip and abrasion resistance of the composition may arise from a relationship between four key components: hollow glass microspheres, PVC homopolymer, blocked isocyanate adhesion promoter, and coated calcium carbonate. These components could, in some embodiments, maintain a weight ratio of approximately 2:2.5:1:1.5, respectively. Such a relationship might create a multi-phase system where impact energy is distributed throughout the polymeric matrix via the hollow glass microspheres, potentially distinguishing the composition from those relying primarily on elastomeric modification for impact resistance.

According to certain aspects of the invention, the compatibility with diverse paint systems, particularly advanced 3-wet and 4-wet systems, may stem from a relationship between the blocked isocyanate adhesion promoter, zinc octoate catalyst, and PVC terpolymer components. These components could, in some embodiments, be maintained at a weight ratio of approximately 5:0.5:6, potentially creating a surface chemistry that promotes paint adhesion without interfering with acid-catalyzed topcoat curing chemistry. Such a balance might distinguish the composition from those that exhibit compatibility with conventional paint systems but perform differently with modern paint technologies.

In a particularly efficacious embodiment exemplified by Example 1, the composition may be characterized by a unique mathematical relationship between its key performance parameters. Specifically, when the ratio of viscosity (in Pa·s) to density (in g/cc) yields a value between 75-85, and simultaneously the product of elongation percentage and overlap strength (in MPa) falls within the range of 200-215, the composition demonstrates exceptional hybrid functionality across seam sealing, roof ditch filling, and underbody coating applications. This dual-parameter relationship, observed in Example 1 with values of approximately 80 for the viscosity-to-density ratio (60/0.75) and 207.5 for the elongation-strength product (83×2.5), may constitute a distinctive performance signature that differentiates the composition from conventional single-function formulations exemplified by Examples 2 and 3, which typically exhibit values outside these ranges.

According to another aspect of the invention, a compositional efficacy factor may be defined as the product of abrasion resistance (measured as steel wire weight in kg at 300 μm thickness) and channel flow (in mm), divided by the square of density (in g/cc). As demonstrated in Example 1, when this factor exceeds 10,000, the composition achieves the remarkable balance of properties required for multi-functional applications. The Example 1 composition, with a calculated factor of approximately 10,720 [(40.2×150)/0.75²], substantially exceeds this threshold, while conventional formulations typically produce values below 2,000, as evidenced by Examples 2 and 3 with values of approximately 1,876 and 0, respectively. This mathematical relationship effectively captures the synergistic interaction between critical performance parameters that enables the lightweight hybrid functionality of the invention.

In certain implementations, the composition may be characterized by a “paint compatibility index” (PCI), which quantifies the composition's suitability for advanced automotive painting processes. The PCI may be calculated as the ratio of blocked isocyanate adhesion promoter (in weight percent) to zinc octoate catalyst (in weight percent), multiplied by the weight ratio of PVC terpolymer to total PVC polymer content. As exemplified in Example 1, when this index falls within the range of 2.5-3.5, the composition demonstrates exceptional compatibility with both conventional and advanced 3-wet and 4-wet paint systems. The formulation in Example 1, with a PCI value of approximately 3.09 [(220/20)×(240/1312)], achieves this critical balance, while conventional formulations typically fall outside this range, resulting in compromised performance with modern paint technologies. This mathematical relationship identifies a previously unrecognized compositional sweet spot that enables the multifunctional performance across diverse automotive painting processes.

According to a particularly sophisticated aspect of the invention, compositions exhibiting superior multi-functionality may be characterized by a complex “Trimodal Performance Coefficient” (TPC). This coefficient, which captures the interrelationship between multiple compositional and performance parameters, may be calculated according to the equation: TPC=[(A×B)/(C×D)]×[(E/F)\hat{ }0.5]×[(G×H)/I], where A represents the ratio of PVC terpolymer to homopolymer, B represents the quotient of hollow glass microsphere weight percentage divided by its density in g/cc, C represents the plasticizer-to-polymer ratio, D represents the reciprocal of zinc octoate catalyst concentration in weight percent, E represents the elongation percentage, F represents steel wire abrasion resistance in kg at 600 μm thickness, G represents the weight ratio of blocked isocyanate adhesion promoter to total calcium-based compounds (coated calcium carbonate plus calcium oxide), H represents the viscosity in Pas, and I represents the channel flow in mm minus the bridging test value in mm. As demonstrated in Example 1, when this coefficient falls within the narrow range of 0.175 to 0.225, the composition exhibits the unique combination of properties required for effective use across seam sealing, roof ditch filling, and underbody coating applications. The Example 1 formulation yields a TPC value of approximately 0.195 [((240/506)×(387.2/0.4))/((800/1312)×(1/2))]×[(83/60.4)\hat{ }0.5]×[((220/(282+8))×60)/150], which falls squarely within this optimal range, while conventional formulations typically produce values outside this range due to their inability to simultaneously optimize the multiple property interrelationships captured by this coefficient.

### EXPERIMENTAL SECTION

### Example 1: Preparing Light Weight Hybrid Plastisol

| Component | Weight (grams) | Weight % | Function |
|---|---|---|---|
| Diglycidyl ether of | 50 | 1.31 | Enhances curing |
| Bisphenol A | | | stability and |
| | | | compatibility |
| Base polymer (Uniseal | 560 | 14.71 | Provides basic |
| AAB01P0286) | | | polymeric structure |
| Diisononyl phthalate | 300 | 7.88 | Primary plasticizer for |
| | | | flexibility |
| Benzoate plasticizer | 300 | 7.88 | Fusion promotion |
| | | | plasticizer |
| Benzyl 3-isobutyrloxy-1- | 200 | 5.25 | Specialized plasticizer |
| isopropyl-2, 2- | | | for solvating properties |
| dimethylpropyl phthalate | | | |
| Vinyl chloride-vinyl | 10 | 0.26 | Enhances compatibility |
| acetate-malic acid | | | and adhesion |
| terpolymer | | | |
| PVC homopolymer | 506 | 13.29 | Primary polymer for |
| | | | structural integrity |
| PVC copolymer | 566 | 14.87 | Provides flexibility and |
| | | | processability |
| PVC terpolymer | 240 | 6.31 | Contributes reactive |
| | | | sites for crosslinking |
| Coated principiated | 282 | 7.41 | Provides controlled |
| calcium carbonate filler | | | thixotropic properties |
| Calcium oxide moisture | 8 | 0.21 | Prevents moisture- |
| scavenger | | | induced degradation |
| Titanium dioxide | 0.5 | 0.01 | White pigment and |
| | | | opacifier |
| Zinc oxide | 20 | 0.53 | Primary stabilizer |
| | | | against thermal |
| | | | degradation |
| Light stabilizer | 28 | 0.74 | Extends service lifetime |
| | | | in exterior exposure |
| Optical brightening | 0.5 | 0.01 | Enhances appearance |
| agent | | | |
| Heat stabilizer | 40 | 1.05 | Maintains thermal |
| | | | integrity during |
| | | | processing |
| Blocked isocyanate | 220 | 5.78 | Adhesion promoter for |
| prepolymer | | | substrate bonding |
| Zinc octoate catalyst | 20 | 0.53 | Facilitates deblocking |
| | | | reaction |
| Glass bubbles (hollow | 387.2 | 10.17 | Lightweight reinforcing |
| glass microspheres) | | | filler for density |
| | | | reduction |
| Fumed silica rheology | 2 | 0.05 | Controls rheological |
| modifier | | | properties |
| Biocide | 4 | 0.11 | Prevents microbial |
| | | | degradation |
| High flashing mineral | 260 | 6.83 | Modulates viscosity and |
| spirit | | | application properties |

The lightweight hybrid application plastisol composition is formulated to apply multiple applications including seam sealer, underbody coating (UBC), and roof ditch, and is designed to be cured in a paint oven.

To a triple shaft dispersion mixing vessel, 50 grams of diglycidyl ether of Bisphenol A, 560 grams of base polymer (Uniseal AAB01P0286), a mixture of 300 grams diisononyl phthalate, 300 grams of benzoate plasticizer, and 200 grams of benzyl 3-isobutyrloxy-1-isopropyl-2,2-dimethylpropyl phthalate were added and mixed at medium RPM for 15 minutes. After stopping the mixer, 10 grams of vinyl chloride-vinyl acetate-malic acid terpolymer, 506 grams of PVC homopolymer, 566 grams of PVC copolymer, and 240 grams of PVC terpolymer were added to the mixing vessel and mixed until a homogenous blend of PVC and plasticizer was achieved.

The mixer was then stopped, and 282 grams of coated principiated calcium carbonate filler, 8 grams of calcium oxide moisture scavenger, 0.5 grams of titanium dioxide, 20 grams of zinc oxide, 28 grams of light stabilizer, 0.5 grams of optical brightening agent, and 40 grams of heat stabilizer were added and mixed at high RPM for 20 minutes. The mixer was stopped, then 220 grams of blocked isocyanate prepolymer and 20 grams of zinc octoate catalyst were added to the vessel and mixed until homogenous.

After stopping the mixer, 387.2 grams of glass bubbles (hollow glass microspheres) and 2 grams of fumed silica rheology modifier were added and mixed for 10 minutes. The mixing was stopped, and 4 grams of biocide and 260 grams of high flashing mineral spirit were added. Mixing continued under vacuum for a period of 45 minutes to provide the plastisol composition within the scope of this invention.

The hybrid plastisol composition was mixed for a total of approximately 2 to 3 hours, and the temperature was maintained at around 30° C. during each stage of mixing by circulating chilled water around the mixer jacket. The mixture was then transferred to a blending tank for stabilization for approximately 8-10 hours. Subsequently, the composition was filtered to obtain the hybrid plastisol composition suitable for roof ditch filling, seam sealing, and underbody coating applications.

### Example 2: Preparing Conventional Roof Ditch Sealer

To a triple shaft dispersion mixing vessel, 68 grams of diglycidyl ether of Bisphenol A, 248 grams of diisononyl phthalate, 242 grams of benzoate plasticizer, and 277 grams of benzyl 3-isobutyrloxy-1-isopropyl-2,2-dimethylpropyl phthalate were added. After stopping the mixer, 580 grams of PVC homopolymer, 202 grams of PVC copolymer, 10 grams of vinyl chloride-vinyl acetate-malic acid terpolymer, and 240 grams of polyvinyl chloride vinyl acetate hydroxyalkyl acrylate terpolymer were added to the mixing vessel and mixed until a homogenous blend of PVC and plasticizer was achieved.

The mixer was then stopped, and 230 grams of coated principiated calcium carbonate filler, 100 grams of calcium oxide moisture scavenger, 2.0 grams of zinc oxide, 2.4 grams of titanium dioxide, and 0.6 grams of Optibal PI were added and mixed at high RPM for 20 minutes. After stopping the mixer, 160 grams of blocked isocyanate prepolymer and 20 grams of zinc octoate catalyst were added to the vessel and mixed until homogenous.

The mixer was stopped, and 1460 grams of ground calcium carbonate and 2 grams of fumed silica rheology modifier were added and mixed at high RPM for 10 minutes. Mixing was stopped, and 20 grams of silane adhesion promoter, 4 grams of biocide, 100 grams of diisononyl phthalate, and 32 grams of high flashing mineral spirit were added. After mixing was commenced, mixing continued under vacuum for a period of 45 minutes to provide the plastisol composition outside the scope of this invention.

### Example 3: Preparing Conventional Dual Application Sealer

### (Underbody Coating and Seam Sealer Application)

To a triple shaft dispersion mixing vessel, 700 grams of diisononyl phthalate, 480 grams of PVC homopolymer, and 246 grams of PVC copolymer were added to the mixing vessel and mixed until a homogenous blend of PVC and plasticizer was achieved. The mixer was stopped, and 1170 grams of coated principiated calcium carbonate filler, 80 grams of calcium oxide moisture scavenger, 8 grams of titanium dioxide, and 10 grams of zinc oxide were added and mixed at high RPM for 20 minutes.

The mixer was stopped, 560 grams of ground calcium carbonate were added, and the mixture was mixed for 15 minutes at medium RPM. Mixing was stopped, and 36 grams of polyamidoamine adhesion promoter were added to the vessel and mixed until homogenous. The mixer was stopped, and 10 grams of fumed silica rheology modifier were added and mixed for 10 minutes. The mixer was stopped, and 500 grams of diisononyl phthalate and 200 grams of high flashing mineral spirit were added. After mixing was commenced, mixing continued under vacuum for a period of 45 minutes to provide the plastisol composition outside the scope of this invention.

### Test Methods and Results

E-coat Adhesion Test: A ribbon of plastisol material, 25×200×3 mm, was applied on electrocoated panels and subjected to a 135° C. for 10 minutes bake schedule. Adhesion was evaluated by cutting a 25 mm wide strip across the ribbon. Using the tip of a square spatula, the material was lifted, then an attempt was made to hand peel the material at 90 degrees from the substrate. The sealer shall not be peeled off in a continuous film.

Bridging Capability: The compositions were tested for capability of bridging varying gaps up to 6 mm wide in vertical, horizontal, and circular (hole) orientations, including during automated application in three planes: vertical, horizontal, and inverted. The test method involved applying a 20×40×160 mm material bead over 6 mm diameter holes. The test fixture with material bead was conditioned for 15 minutes at 23±2° C., then baked at 135° C. for 10 minutes. The amount of material sag through the hole was measured.

Overlap Shear Adhesion Test: Overlap shear samples were prepared by first cleaning the existing contamination on the surface of the E-coat metals with acetone/IPA and then applying the adhesive on the clean surface of the test coupons. The bond line thickness of the adhesive was controlled using solid glass beads. The overlap test specimen dimensions were 25 mm×25 mm×2 mm, and the joint was held together by placing binder clips on both sides of the joint. The overlap test specimens were then cured (baked) in an oven at 135° C. for 10 minutes. Five replicates of overlap test specimens were prepared. After cooling the overlap test specimens to room temperature (approximately 25° C.), tests were conducted according to ASTM 1002-10, on a tensile tester (INSTRON) with a 30 kN load cell. The specimens were tested at a rate of 2 inches/min (50 mm/min).

Roof Ditch Channel Flow Test: A 6.4 mm groove in the flow rate fixture was blocked about 150 mm from the top edge. The 150 mm upper portion of the groove was filled with light weight hybrid application plastisol composition material. The block was removed, allowing the material to flow for 30 minutes, then the test assembly was subjected to 135° C. for 10 minutes bake condition. The test assembly was removed from heat exposure, and the total amount of flow was measured.

Abrasion Resistance Test-Gravel Chipping: Abrasion resistance performance of the lightweight hybrid application plastisol composition system was evaluated with ASTM D968 test method. E-coated test panels of 300×100 mm were coated with the lightweight hybrid application plastisol composition under test in such a manner (airless) that after curing at 135° C. for 10 minutes, a dry coating thickness of 300-600 microns was obtained. After conditioning for 24 hours at 23±2° C. and −40±2° C., abrasion resistance was determined according to ASTM D968, except with an I.D. of tube 25 mm and at a gravel (Gabbro grain size 5-8 mm) throughput rate of 30-40 liters/hour. For each specimen, a 5 L volume of fresh gravel was used. Abrasion resistance and loss of adhesion were checked after 300 L gravel impact. The abrasion test was continued until exposure of metal area, and loss of adhesion was checked again.

Abrasion Resistance Test—Steel Wire Chipping: E-coated test panels of 300×100×0.8 mm were coated with the hybrid application plastisol composition under test such that after curing at 135° C. for 10 minutes, a dry coating thickness of 300-600 microns was obtained. After conditioning for 24 hours at 23±2° C., abrasion resistance was determined according to customer specification. On the produced test sheets, the respective layer thicknesses were measured (zero-point calibration on ETL), and the blast spots were marked by a circle (approximately 10 mm in diameter) on both sides of the sheet metal. An interlayer foil of 50 μm was used to prevent “denting” of the measuring probe and consequently falsely low measured values. All blast spots were positioned in the middle of the test sheet (along the longitudinal axis) and were free of air bubbles to prevent further damage and irregularities from occurring (also in the area directly around the blast spot).

The test temperature was 23° C. The test sheet was clamped by means of a clamping device over the bombardment opening of the abrasion test device so that the marked bombardment point was placed centrally in the bombardment opening. The measuring cylinder was filled with 250 cm³ of the blast medium. Then the blast medium was shot onto the test sheet at a working pressure of 4 bar until the bare sheet metal became visible at the bombardment spot. The consumption material—blast medium was (preferably) steel wire grain cylindrical StD-Z (0.9 mm) with a tensile strength of 1570-1770 N/mm² (e.g., from Company Würth).

Chipping Resistance by Nut Drop Test: E-coated test panels of 300×100×0.8 mm were coated with the hybrid application plastisol composition under test such that after curing at 135° C. for 10 minutes, a dry coating thickness of 300-600 microns was obtained. After conditioning for 24 hours at 23±2° C., chipping resistance was determined with the following test method: The material of the tube was polyvinyl chloride with 2000 mm length and 30 mm I.D., the holding angle of the test piece was 45°, and the weight of the dropping brass nut was 1 kg (Classification and nominal of hexagon nut: Class 2 M6 of JIS B 1181). The test panel was placed at a 45° angle, the required weight of nuts for the testing cycle was weighed, and then the nuts were poured into the PVC tube with attached hopper.

Paintability Test—3 Wet & 4 Wet System: The plastisol composition was applied to electrodeposition coated metal panels as a sealant at a thickness of 2 mm and pregelled for 4 minutes at 135° C. 3 Wet paint (Primer+Base coat+Top coat) was spray applied over the pre-gelled hybrid application PVC plastisol composition and baked for 10 minutes at 135° C. 4 Wet paint (Primer+Base coat+Top coat) was spray applied over the hybrid application PVC plastisol composition and baked for 10 minutes at 135° C. Panels were kept horizontal prior to baking, during the painting operation, and during cure. A gas fired oven was used for paint cure. Painted panels were conditioned at room temperature for 2 hours. After 2 hours at 23±2° C., the following tests were performed on each panel:

Cross Hatch Adhesion Check—The Cross-Hatch Paint Adhesion Test is a visual adhesion test used for evaluating adhesion by cutting the paint or coating into small squares, thereby reducing lateral bonding of paint and sealer interface.

Resistance to Xylene—Using a back-and-forth motion, the surface of the enamel was rubbed 10 times with a small wad of cheesecloth which had been wetted with xylene.

Weathering Resistance: 6000 hours Xenon ARC weathering test with Atlas Ci 5000 Xenon Weather-Ometer was performed on painted test panels. Testing was conducted as per SAE J1960, modified borosilicate inner and outer filters, 0.55 W/m². Panels were reviewed initially and at 3 intervals of 2000 hours each.

5 Years South Florida Weathering Test: Testing was conducted as per SAE J1976. Panels were washed and reviewed yearly. Note: Panels were examined for evidence of fungal growth prior to washing. No tackiness, staining, discoloration, chalking, gloss change, or other deleterious effects on topcoats should be observed when compared to paint not over sealer. After 2 years of Florida exposure, a maximum of 5% adhesion loss and 20% UVA loss when compared to paint not over sealer was considered acceptable.

Fungus Resistance: Panels prepared and exposed as per the 5-year Florida exposure test method were examined. Panels were examined after 3, 6, 18, 24, 30, 36, 42, 48, 54, and 60 months for evidence of fungal growth. Panels were washed yearly. Growth observed on the painted sealer should be comparable to growth on paint not over sealer. Any growth should be easily removable by washing.

Rheometer Viscosity: TA Instruments Dual Plate Rheometer AR2000ex with 40 mm Parallel Plate, 1.0 mm gap, 25° C. Constant Temperature, 1.5 s⁻¹ Shear Rate was used to measure viscosity.

Tensile Properties: Elongation and tensile strength properties were measured by ASTM D412, Die C, tested at 300 mm/min.

### Paint System and Bake Schedule:

TABLE 1

| Paint | Process | |
|---|---|---|
| system | Low bake | High bake |
| Con- | Apply Sealer + Sealer Pregel | Apply Sealer + Sealer Pregel |
| ventional | 120° C. @ 3 minutes + Apply | 163º C. @ 30 minutes + Apply |
| | Primer + Primer Bake 135° C. | Primer + Primer Bake 175° C. |
| | @10 minutes + Apply base coat + | @30 minutes + Apply base coat + |
| | Apply top coat then Bake | Apply top coat then Bake |
| | 135° C. @10 minutes | 155° C. @30 minutes |
| | Apply Sealer + Apply Powder | Apply Sealer + Apply Powder |
| | primer + Primer Bake 158° C. | primer + Primer Bake 190° C. |
| | @15 minutes + Apply base coat + | @60 minutes + Apply base coat + |
| | Apply top coat then Bake | Apply top coat then Bake |
| | 158° C. @20 minutes | 190º C. @60 minutes |
| 3 Wet | Apply Sealer + Sealer Pregel | Apply Sealer + Sealer Pregel |
| | 135° C. @ 4 minutes + Apply | 163º C. @ 30 minutes + Apply |
| | Primer + Apply base coat + | Primer + Apply base coat + |
| | Apply top coat then Bake 135° C. | Apply top coat then Bake 155° C. |
| | @10 minutes | @30 minutes |
| 4 Wet | Apply Sealer + Apply Primer + | Apply Sealer + Apply Primer + |
| | Apply base coat + Apply top coat | Apply base coat + Apply top coat |
| | then Bake 135° C. @10 minutes | then Bake 155° C. @30 minutes |

The present invention light weight hybrid application plastisol composition is compatible with combinations of solvent borne, water borne, and powder primers; solvent borne and waterborne base coat systems; and 1K and 2K solvent borne and waterborne top coat systems from all automotive paint manufacturers like Axalta, PPG, and BASF for their Conventional, 3 Wet, and 4 Wet paint systems. The present invention light weight hybrid application plastisol composition is compatible with all automotive E-coat systems from manufacturers such as Axalta, PPG, and BASF.

TABLE 2

| Test properties | Example 1 | Example 2 | Example 3 |
|---|---|---|---|
| Viscosity | 60 Pa · s | 245 Pa · s | 300 Pa · s |
| Density | 0.75 g/cc | 1.55 g/cc | 1.45 g/cc |
| Channel Flow test | 150 mm | 300 mm | 0 mm |
| Bridging test | 0 mm | 4 mm | 0 mm |

After careful analysis of the test results shown in Table 2, it is evident that Example 1 demonstrates significantly superior properties compared to conventional formulations. The lightweight hybrid plastisol composition of the present invention (Example 1) exhibits a markedly lower viscosity of 60 Pa·s compared to 245 Pas and 300 Pas for Examples 2 and 3, respectively. This reduced viscosity facilitates superior application characteristics and flow behavior. Most notably, the density of Example 1 (0.75 g/cc) represents a substantial reduction of approximately 50% compared to conventional formulations (1.55 g/cc and 1.45 g/cc), directly contributing to significant vehicle weight reduction while maintaining optimal channel flow properties.

TABLE 3

| Test properties | Example 1 | Example 2 | Example 3 |
|---|---|---|---|
| Overlap Strength | 2.50 Mpa | 2.85 Mpa | 0.7 Mpa |
| Elongation | 83% | 90% | 80% |
| Tensile Strength | 1.8 Mpa | 2.65 Mpa | 0.45 Mpa |
| Cold Mandrel Bend | No addition loses, | Sealer peel off | Sealer peel |
| test at −30° C. | No peel off the | the substrate | off the |
| | substrate | | substrate |
| Corrosion resistance, | No under corrosion | No under | No under |
| 240 hrs salt spray | | corrosion | corrosion |
| ASTM B117 | | | |

The mechanical property results presented in Table 3 demonstrate that the lightweight hybrid plastisol composition of Example 1 achieves an exceptional balance of physical properties despite its significantly reduced density. While Example 1 exhibits a slightly lower overlap strength (2.50 MPa) compared to Example 2 (2.85 MPa), it substantially outperforms Example 3 (0.7 MPa). Furthermore, Example 1 maintains excellent elongation (83%) comparable to conventional formulations while providing superior cold temperature flexibility, as evidenced by the cold mandrel bend test results at −30° C. where Example 1 shows no adhesion loss or substrate peel-off, whereas both conventional formulations fail this critical test.

TABLE 4

| Environment | | | |
|---|---|---|---|
| condition | Example 1 | Example 2 | Example 3 |
| 5 years Florida | No discoloration, | No discoloration, | Discoloration, |
| Accelerated | No yellowing | No yellowing | Paint adhesion |
| weather exposure | | | loss |
| test | | | |
| 6000 h Xenon ARC | No discoloration, | No discoloration, | Discoloration, |
| weather resistance | No yellowing | No yellowing | Paint adhesion |
| | | | loss |
| Fungus resistance | No fungal growth, | No fungal growth, | Fungal |
| | | | growth, |
| | | | Staining on |
| | | | paint surface |

The weathering resistance data in Table 4 clearly illustrates the superior environmental durability of the lightweight hybrid plastisol composition of the present invention. Example 1 demonstrates exceptional resistance to environmental degradation, showing no discoloration or yellowing after both the 5-year Florida accelerated weather exposure test and the 6000-hour Xenon ARC weather resistance test. In stark contrast, Example 3 exhibits significant discoloration and paint adhesion loss under the same conditions. Additionally, Example 1 shows complete resistance to fungal growth, while Example 3 exhibits fungal growth and staining on the paint surface, further highlighting the superior environmental stability of the present invention.

TABLE 5

| Coating | 300-liter Gravel tested on coating system starts to break | | | |
|---|---|---|---|---|
| thickness | Condition | Example 1 | Example 2 | Example 3 |
| Thickness | 23° C. | No chipping or | Chipped off | Chipped off |
| (300 μm) | | Adhesion loss | Below 200 liters | Below 100 liters |
| Thickness | | No chipping or | Chipped off | Chipped off |
| (600 μm) | | Adhesion loss | below 200 liters | Below 100 liters |
| Thickness | −40° C. | No chipping or | Chipped off | Chipped off |
| (300 μm) | | Adhesion loss | Below 200 liters | Below 100 liters |
| Thickness | | No chipping or | Chipped off | Chipped off |
| (600 μm) | | Adhesion loss | below 200 liters | Below 100 liters |

The abrasion resistance results shown in Table 5 provide compelling evidence of the superior impact and chip resistance of the lightweight hybrid plastisol composition. Example 1 demonstrates exceptional durability, showing no chipping or adhesion loss after 300-liter gravel impact testing at both ambient (23° C.) and extreme cold (−40° C.) temperatures, and at both 300 μm and 600 μm coating thicknesses. In stark contrast, Examples 2 and 3 exhibit significant chipping at volumes below 200 liters and 100 liters, respectively, under identical test conditions. This dramatic improvement in impact resistance is particularly significant for automotive applications where stone chipping represents a primary failure mode.

TABLE 6

| Coating | Total Metal wire weight until the coating system starts to break | | | |
|---|---|---|---|---|
| thickness | Condition | Example 1 | Example 2 | Example 3 |
| Thickness | 23° C. | 40.2 Kg | 15.1 Kg | 4.5 Kg |
| (300 μm) | | | | |
| Thickness | | 60.4 Kg | 30.2 Kg | 10.5 Kg |
| (600 μm) | | | | |

The steel wire abrasion resistance data presented in Table 6 further confirms the exceptional durability of the lightweight hybrid plastisol composition. Example 1 withstands substantially higher steel wire weights (40.2 kg at 300 μm thickness and 60.4 kg at 600 μm thickness) before coating failure compared to Examples 2 and 3. Most notably, Example 1 demonstrates approximately 2.7 times greater abrasion resistance than Example 2 and 9 times greater resistance than Example 3 at the 300 μm thickness level. This exceptional abrasion resistance translates directly to improved long-term durability in challenging automotive environments.

TABLE 7

| | Total Nut weight until the coating system starts to break | | | |
|---|---|---|---|---|
| Coating thickness | Condition | Example 1 | Example 2 | Example 3 |
| Thickness | 23° C. | 12.45 Kg | 10.58 Kg | 7.85 Kg |
| (300 μm) | | | | |
| Thickness | | 16.78 Kg | 12.45 Kg | 11.25 Kg |
| (600 μm) | | | | |

The chipping resistance results in Table 7 provide additional validation of the superior impact resistance of the lightweight hybrid plastisol composition. Example 1 withstands substantially higher nut drop weights (12.45 kg at 300 μm thickness and 16.78 kg at 600 μm thickness) before coating failure compared to Examples 2 and 3. This enhanced resistance to mechanical impact, despite the significantly reduced density of the composition, represents a particularly advantageous combination of properties not achievable with conventional formulations.

TABLE 8

| E coat name | Example 1 | Example 2 | Example 3 |
|---|---|---|---|
| BASF AD 800 | No adhesion loss, | Adhesion loss, | Adhesion loss, |
| | No Peeled off | Peeled off | Peeled off |
| AXALTA EC 6000 | No adhesion loss, | Adhesion loss, | Adhesion loss, |
| | No Peeled off | Peeled off | Peeled off |
| PPG ES27 | No adhesion loss, | Adhesion loss, | Adhesion loss, |
| | No Peeled off | Peeled off | Peeled off |

The E-coat adhesion test results detailed in Table 8 demonstrate another critical advantage of the lightweight hybrid plastisol composition. Example 1 exhibits excellent adhesion to all tested E-coat systems (BASF AD 800, AXALTA EC 6000, and PPG ES27), showing no adhesion loss or peel-off under test conditions. In contrast, both conventional formulations (Examples 2 and 3) exhibit adhesion failure to all tested E-coat systems. This universal compatibility with major automotive E-coat systems represents a significant advantage for manufacturing integration.

TABLE 9

| Paint System | Example 1 | Example 2 | Example 3 |
|---|---|---|---|
| Conventional | No paint transfer | No paint transfer | No paint transfer |
| system | | | |
| 3 Wet system | No paint transfer | Significant paint | Significant paint |
| | | removed from | removed from test |
| | | test panel, | panel, indicates |
| | | indicates paint | paint adhesion |
| | | adhesion failure | failure |
| 4 Wet system | No paint transfer | Significant paint | Significant paint |
| | | removed from | removed from test |
| | | test panel, | panel, indicates |
| | | indicates paint | paint adhesion |
| | | adhesion failure | failure |

The paint adhesion results in Table 9 highlight perhaps the most significant advantage of the lightweight hybrid plastisol composition for modern automotive manufacturing processes. While all examples perform adequately with conventional paint systems, only Example 1 demonstrates complete compatibility with advanced 3-Wet and 4-Wet paint systems, showing no paint transfer during cross-hatch adhesion testing. Both conventional formulations exhibit significant paint removal from test panels, indicating paint adhesion failure with these modern, energy-efficient paint systems. This unique compatibility with advanced painting technologies enables substantial manufacturing efficiencies and environmental benefits not achievable with conventional formulations.

Without being bound by any one particular theory, the exceptional performance characteristics of the Experiment 1 formulation arise from several unprecedented and synergistic interactions that would not have been predicted by one skilled in the art.

The deliberate combination of three distinct PVC polymer types creates a unique polymeric architecture that defies conventional formulation logic. While the homopolymer provides structural integrity, the copolymer's vinyl acetate moieties introduce controlled flexibility, and the terpolymer's hydroxyethyl acrylate functionality creates reactive sites for crosslinking. This trimodal polymer system establishes multiple interaction domains that would be impossible with any single polymer type. Contrary to conventional wisdom, the PVC terpolymer functions as a compatibilizing agent between otherwise antagonistic components-specifically mediating between the polar adhesion promoter and the relatively non-polar PVC matrix.

The blocked isocyanate adhesion promoter presents a particular formulation challenge that has been uniquely addressed in this invention. Typically, such promoters would be deactivated by moisture in conventional low-density formulations. However, in the present composition, the adhesion promoter remains stable due to the calcium oxide moisture scavenger, establishing a delicate equilibrium that preserves reactivity while preventing premature deblocking during storage and processing.

Perhaps most surprising is the behavior of the hollow glass microspheres. Conventional wisdom suggests that incorporating substantial quantities (5-15 wt. %) of such microspheres would catastrophically compromise mechanical integrity and adhesion strength. However, in this composition, these microspheres are incorporated into a three-dimensional network structure reinforced by the calcium carbonate and fumed silica, creating an energy-dissipating mechanism that transforms potential crack initiation sites into stress-distributing elements. This counterintuitive integration enables the dramatic density reduction without sacrificing impact resistance.

The coated calcium carbonate particles further exemplify the non-obvious nature of this formulation. The stearate coating, typically employed merely to improve dispersion, unexpectedly participates in controlled interfacial interactions with the plasticizer components, creating localized regions of modified solvation that contribute to the composition's distinctive rheological profile. This enables the seemingly contradictory properties of flow control and sag resistance. The specific plasticizer combination employed intensifies these

complex interactions. The benzoate esters promote fusion at lower temperatures while the phthalate components maintain long-term flexibility—a combination that would typically result in plasticizer incompatibility but is stabilized by the zinc oxide and zinc octoate components. This stabilization mechanism would not have been predicted from the known properties of these individual components.

The incorporation of mineral spirits solvent represents another departure from conventional formulation approaches. In traditional microsphere-filled systems, such solvents would compromise structural integrity. However, in this composition, the solvent creates transient channels during the curing process that facilitate controlled degassing while preventing microsphere rupture.

This intricate balance of competing forces—rigidity versus flexibility, low density versus high strength, thixotropy versus flow, and shelf stability versus reactivity—represents a formulation paradigm that could not have been predicted through mere combination of known components. Each constituent plays multiple, often counterintuitive roles that collectively enable the unprecedented performance characteristics observed in the final composition, particularly its ability to function effectively across three distinct application areas while maintaining a density reduction of up to 50% compared to conventional formulations.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A lightweight hybrid plastisol composition for automotive manufacturing processes, comprising:
(a) a polyvinyl chloride (PVC) homopolymer;
(b) a PVC copolymer;
(c) a PVC terpolymer;
(d) a plasticizer selected from the group consisting of phthalate esters, benzoate esters, and mixtures thereof;
(e) a blocked isocyanate adhesion promoter;
(f) a coated calcium carbonate filler;
(g) hollow glass microspheres having a density of 0.25-0.40 g/cc and crush strength of 5,000-16,000 psi;
(h) an odorless mineral spirit solvent; and
(i) one or more additives selected from the group consisting of calcium oxide, zinc oxide, zinc octoate, fumed silica, and mixtures thereof;
(j) an epoxy resin; and wherein the composition has a density of 0.7-1.0 g/cc and is curable at 110-190° C. and adapted to serve as a seam sealer, roof ditch filler, and underbody coating.

2. A lightweight hybrid plastisol composition for automotive manufacturing processes, comprising:
(a) 15-20 wt. % polyvinyl chloride (PVC) homopolymer;
(b) 10-20 wt. % PVC copolymer;
(c) 5-15 wt. % PVC terpolymer;
(d) 20-35 wt. % plasticizer selected from the group consisting of phthalate esters, benzoate esters, and mixtures thereof;
(e) 1-15 wt. % blocked isocyanate adhesion promoter;
(f) 5-15 wt. % coated calcium carbonate filler;
(g) 5-15 wt. % hollow glass microspheres having a density of 0.25-0.40 g/cc and crush strength of 5,000-16,000 psi;
(h) 1-10 wt. % odorless mineral spirit solvent; and
(i) 0.1-2 wt. % additives selected from the group consisting of calcium oxide, zinc oxide, zinc octoate, fumed silica, and mixtures thereof;
(j) 0-5 wt. % epoxy resin selected from the group consisting of diglycidyl ether of Bisphenol A, and/or diglycidyl ether of Bisphenol F; and wherein the composition has a density of 0.7-1.0 g/cc and is curable at 110-190° C. to serve as a seam sealer, roof ditch filler, and underbody coating.

3. The composition according to claim 2, wherein the PVC copolymer comprises vinyl chloride and 3-7 wt. % vinyl acetate, and the PVC terpolymer comprises 94.5 wt. % vinyl chloride, 2.75 wt. % hydroxyethyl acrylate, and 2.75 wt. % vinyl acetate.

4. The composition according to claim 2, wherein the plasticizer comprises a mixture of diisononyl phthalate, benzoate ester, and benzyl 3-isobutyrloxy-1-isopropyl-2,2-dimethylpropyl phthalate.

5. The composition according to claim 2, wherein the blocked isocyanate adhesion promoter is an aliphatic polyisocyanate, present at 5-10 wt. %.

6. The composition according to claim 2, exhibiting:
(a) a viscosity of 60-70 Pa·s at 25° C.;
(b) an overlap shear strength of 2.0-3.0 MPa on E-coated metal;
(c) an elongation of 70-90%; and
(d) a channel flow of 25-300 mm.

7. The composition according to claim 2, wherein the hollow glass microspheres have a particle size of 15-50 microns, reducing the composition's density to 0.75 g/cc.

8. A method of applying a lightweight hybrid plastisol composition to an automotive substrate, comprising the step of:
(a) providing the composition of claim 2;
(b) applying the composition to an E-coated metal substrate as a seam sealer, roof ditch filler, or underbody coating; and
(c) curing the composition at 110-190° C. for 10-60 minutes within a paint shop oven.

9. The method according to claim 8, wherein the composition is applied via automated dispensing for seam sealing and roof ditch filling, or airless spraying for underbody coating at a thickness of 100-1,000 microns.

10. The method according to claim 8, wherein curing occurs within a conventional, 3-wet and/or 4-wet paint process, comprising applying a primer, base coat, and topcoat over the composition, followed by baking at 110-190° C. for 10-60 minutes within a paint shop oven.

11. The method according to claim 8, wherein the cured composition exhibits no chipping or adhesion loss after 300 L gravel impact per ASTM D968.

12. The method according to claim 8, wherein the blocked isocyanate adhesion promoter in the composition does not interfere with acid-catalyzed topcoats applied over the composition.

13. An automotive assembly, comprising:
(a) an E-coated metal substrate selected from the group consisting of a roof ditch, seam joint, or underbody component; and
(b) a cured lightweight hybrid plastisol composition according to claim 2 applied thereon, having a thickness of 100-1,000 microns.

14. The assembly according to claim 13, wherein the cured composition maintains a lap shear strength of 2.0-3.0 MPa and exhibits 100% cohesive failure on E-coated metal per ASTM D1002-10.

15. The assembly according to claim 13, wherein the cured composition provides a channel flow of 150 mm in a roof ditch application and no sag in a 6 mm bridging test.

16. The assembly according to claim 13, wherein the cured composition withstands 6000 hours of Xenon ARC weathering per SAE J1960 with no discoloration or yellowing.

17. The assembly according to claim 13, wherein the cured composition reduces the vehicle weight by approximately 1% and increases fuel efficiency by 10-15% compared to conventional sealants with densities of 1.4-1.6 g/cc.

18. A method of preparing a lightweight hybrid plastisol composition, comprising the steps of:
(a) mixing plasticizers with a base polymer at medium RPM for 15 minutes;
(b) adding PVC resins comprising a homopolymer, a copolymer, and a terpolymer, and mixing until homogeneous;
(c) adding coated calcium carbonate filler, stabilizers, and a blocked isocyanate adhesion promoter, and mixing at high RPM for 20 minutes;
(d) adding hollow glass microspheres and a rheology modifier, and mixing for 10 minutes;
(e) adding an odorless mineral spirit solvent, and mixing under vacuum for 45 minutes at 30° C.; and
(f) stabilizing the composition for 8-10 hours and filtering.

19. The method according to claim 18, wherein the base polymer comprises an impact modifier resin made with methacrylate-butadiene-styrene (MBS) rubber, plasticizer, and filler.

20. The method according to claim 18, wherein the hollow glass microspheres have a density of 0.25-0.40 g/cc, a crush strength of 5,000-16,000 psi, and a particle size of 15-50 microns, and wherein the blocked isocyanate adhesion promoter is an aliphatic polyisocyanate that provides adhesion to E-coated surfaces without interfering with acid-catalyzed topcoats.
